(19) United States
(12) Patent Application Publication
(10) Pub. No.: US 2015/0170193 A1
(43) Pub. Date: Jun. 18, 2015

(54) SYSTEM AND METHOD FOR DISTRIBUTING AND PROCESSING COUPONS

(71) Applicant: The Grocer Exchange, LLC, Evanston, IL (US)

(72) Inventors: Robert H. Lounsbury, JR., Evanston, IL (US); Frank Edward Romero, Canton, MA (US)

(73) Assignee: The Grocer Exchange, LLC, Evanston, IL (US)

(21) Appl. No.: 14/106,063

(22) Filed: Dec. 13, 2013

(51) Int. Cl. G06Q 30/02

(52) U.S. Cl. CPC G06Q 30/0238

(57) ABSTRACT

A coupon distribution and processing platform (CDPP) allows its members/constituents to receive services associated with the purchase of consumer products. Specifically, a shopper, registered with the CDPP, accesses an account and electronically selects one or more coupons to be associated with a coupon card. Thereafter, when the shopper's coupon card is scanned or credit card is scanned at a particular grocer entity, the accounts associated with the shopper and grocer entity are credited, while the account associated with the manufacturer is debited. Further, the shopper, the manufacturer, and the grocer entity, each having a corresponding account, may select one or more services provided by the CDPP utilizing by a CDPP website.

### BACKGROUND OF THE INVENTION

1. Field of the Invention

The present invention is directed to distributing and processing coupons, and more particular to a system and method for coupon distribution and processing.

2. Background Information

Traditional paper coupons are typically issued by manufacturers and purveyors of consumer packaged goods to consumers for the purposes of granting discounts or rebates as a purchase incentive. Paper coupons suffer many deficiencies that include, inter alia, a high cost for coupon distribution and handling, inconvenience to the shopper, potential fraud, reconciliation delay, slow and imprecise tracking, and limited audit control, etc. Further, with traditional paper coupons, shoppers typically receive their savings by either being charged less at the point of sale (i.e., at the register), or receiving the savings as cash/coins at the register of a retailer. In both instances, the savings may not be fully appreciated and/or utilized in the most advantageous way for the shopper. Moreover, the retailer must bear the financial burden of the cash discount or rebate until such time as they are compensated through a coupon settlement process. In addition, the retailer has to be adversely affected by the long delay in clearinghouse settlement and essentially carrying the face value float of the coupon for an extended period of time. Further, manufacturers of products and grocery stores that sell the products do not typically have an easy way to obtain statistical information associated with the sale of products to customers. They also typically lack the capability to implement services that would be economically and strategically beneficial.

### SUMMARY OF THE INVENTION

In an illustrative embodiment, a coupon distribution and processing platform (CDPP) allows its members/constituents to receive services associated with the purchase of consumer products. Specifically, a shopper, registered with the CDPP, accesses an account with the CDPP, via exemplary web page(s), and may electronically select (i.e., “load”) one or more coupons to be associated with a coupon card. The one or more coupons are associated with products manufactured by one or more manufacturers registered with the CDPP, and sold at grocer entities registered with the CDPP. When the shopper's coupon card is scanned at a point of service/sale (POS) node (e.g., cash register) associated with a particular grocer entity, the account associated with the shopper is credited based on a value of the electronic coupon(s). The electronic coupon(s) may have been previously selected by the shopper and associated with the coupon card, or may be automatically provided to the shopper. In an alternative embodiment, the shopper's credit card, associated with a financial services institution, may be scanned at the grocer entity. The financial services institution may provide a unique identifier, associated with the shopper, to the CDPP, so that the CDPP can credit the shopper's account based on the value of the electronic coupon(s).

In an illustrative embodiment, the accumulated savings may be stored in a financial account associated with the shopper and maintained by a particular banking institution for later user. For example, the accumulated savings obtained utilizing the coupon card or credit card may be applied towards a minimum payment requirement associated with a credit card of the shopper, or as consumer/family payment events (e.g., back to school spending, vacations, etc.). Moreover, and in response to the scanning of the coupon card at the POS node or the scanning of the credit card, the grocer entity receives a handling fee from the CDPP for handling the electronic coupon, and the manufacturer is charged/debited a fee by the CDPP.

Further, the shopper, the manufacturer, and the grocer entity, each having an account with the CDPP, may select one or more services provided by the CDPP. These services may be selected utilizing one or more graphical user interface (GUI) screens associated with the CDPP. Such services include, but are not limited to, receiving promotions, advertising services, receiving statistical data regarding the sales of products.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 is an exemplary network environment in which the principles of the present invention may be implemented;

FIG. 2 is a block diagram of an exemplary coupon distribution and processing platform in accordance with an illustrative embodiment of the present invention;

FIG. 3 is an exemplary screenshot of a web page illustrating a graphical user interface (GUI) screen in accordance with an illustrative embodiment of the present invention;

FIG. 4 is an exemplary screenshot of a web page illustrating a GUI screen after selecting a manufacturer tab in accordance with an illustrative embodiment of the present invention;

FIG. 5 is an exemplary screenshot of a web page illustrating a GUI screen after selecting a grocer tab in accordance with an illustrative embodiment of the present invention;

FIG. 6 is an exemplary flowchart detailing the steps of a procedure for interaction between a manufacturer node and/or a grocer entity node with the CDPP in accordance with an illustrative embodiment of the present invention;

FIG. 7 is an exemplary screenshot of a web page illustrating a GUI screen after selecting a shopper tab in accordance with an illustrative embodiment of the present invention;

FIG. 8 is an exemplary flowchart detailing the steps of a procedure for interaction between a shopper and the CDPP in accordance with an illustrative embodiment of the present invention; and

FIGS. 9A and 9B are an exemplary flowchart detailing the steps of a procedure for distributing and processing coupons in accordance with an illustrative embodiment of the present invention.

### DETAILED DESCRIPTION OF AN ILLUSTRATIVE EMBODIMENT

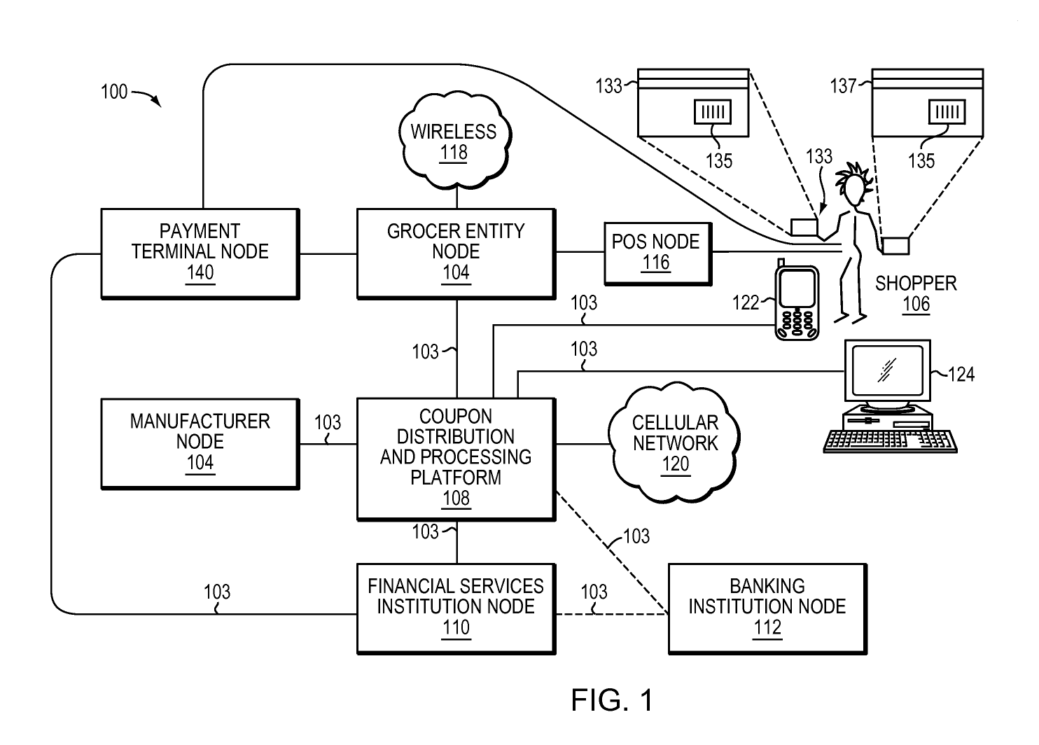

FIG. 1 is an exemplary network environment 100 in which a manufacturer node 102, a grocer entity node 104 (e.g., retailer) having one or more point of service/sale (POS) nodes 116, a shopper 106, a coupon distribution and processing platform (CDPP) 108, a financial services institution node 110, and a banking institution node 112 are interconnected by communication links 103 of a computer network. As known by those skilled in the art, a computer network or data network is a telecommunications network that allows hardware devices (e.g., computers) to exchange data. In computer networks, hardware devices pass data to each other along data connections, such as exemplary communication links 103.

The communication links 103 (network links) between the nodes are established using either cable media or wireless media, as known by those skilled in the art. Further, the CDPP 108 may communicate over cellular network 120 with one or more mobile devices 122. As known by those skilled in the art, the cellular network 120 (i.e., mobile network) is a wireless network distributed over land areas called cells, each served by at least one fixed-location transceiver, known as a cell site or base station. In the cellular network 120, each cell uses a different set of frequencies from neighboring cells, to avoid interference and provide guaranteed bandwidth within each cell. For example, the CDDP 108 may facilitate the sending of messages to mobile devices over the cellular network 120.

Each entity may directly or indirectly communicate with the CDPP 108 over the communication links 103 of the computer network. The manufacturer node 102 may be associated with a consumer packaged goods (CPG) company, e.g., a manufacturer of a product that may be purchased by a shopper. For example, the shopper may purchase groceries, electronics, or other products/services.

The grocer entity node 104 may be associated with a store or entity that sells products/services to consumers/shoppers, and that utilize the POS nodes 116. The POS node 116 may comprise hardware and/or software loaded thereon to allow the CDDP 108 to perform a variety of functions. Specifically, the loaded hardware and/or software illustratively allows the CDPP 108 to determine whether products purchased by the shopper have an associated electronic coupon, to perform various credits and debits. Further, data, compiled at particular POS nodes 116 (e.g., cash register data), may be transmitted over a wireless network 118 or any type of network and stored, for example, at the CDPP 108. The financial services institution node 110 may be associated with a financial institution, e.g., a credit card company, that provides financial functions (e.g., credit checks, lines of credit) to its members. Financial services institution node 110 has associated payment terminal nodes 140 that are utilized at the grocer entity node 104.

The banking institution node 112 is an entity associated with a banking institution that provides banking functions (e.g., loan, maintaining banking accounts) to its members. It is noted that financial institutions and banking institutions adhere to particular rules and regulations as set forth by particular governing bodies. For example, banks in a particular state may have to adhere to federal banking laws as well as the banking laws of the particular state. Further, it is noted that the banking institution node 112 may be the same entity as the financial services institution node 110. As such, the description of a separate financial services institution node 110 and a banking institution node 112 should be taken as exemplary only. The banking institution node 112 may be directly connected to the CDPP 108, or may be indirectly connected to the CDPP 108, through, for example, the financial services institution node 110 (as seen by the dotted lines).

Shopper 106 may be a consumer who purchases products or services from particular stores utilizing the novel coupon card 133 associated with the program that describes the interaction between the various entities and the CDPP 108, as described below. The coupon card 133 may be similar to a credit card, or a different card that has a bar code, or some other sort of unique signature 135. In alternative embodiments, the coupon card 133 may be a virtual card, for example, that the shopper may have “stored” on its mobile device or configured on a mobile application of the mobile device. Moreover, the shopper has a credit card 137, provided by the financial institution node 110, wherein the credit card has a signature 135. The credit card 137 may be scanned at the payment terminal node 140 when the shopper 106 wishes to purchase a product at grocer entity node 104, as known by those skilled in the art. Further, the shopper 106 may utilize a mobile phone 122 and/or computer 124 to interact with the different entities (e.g., POS node 116, CDPP 108, etc.) in FIG. 1. Those skilled in the art will understand that any number of nodes, devices and/or links may be used in environment 100.

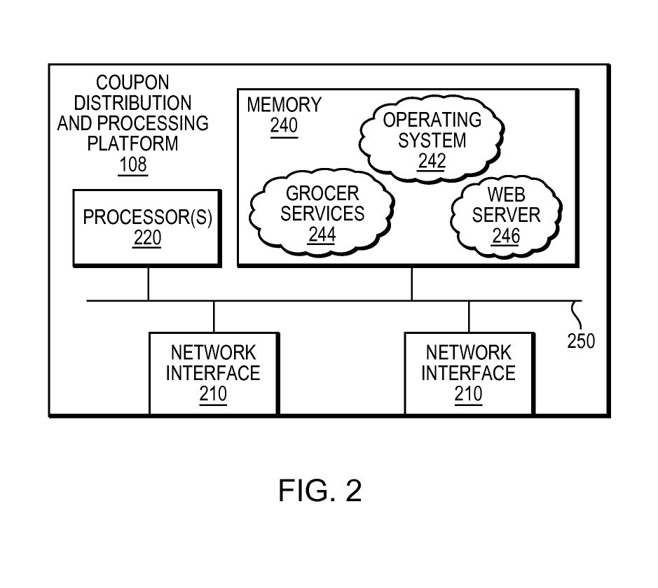

FIG. 2 is an exemplary block diagram of an exemplary CDPP 108 that may be used with one or more embodiments described herein. The CDPP 108 may comprise a plurality of network interfaces 210, one or more processors 220, and a memory 240 interconnected by a system bus 250. The network interfaces 210 contain the mechanical, electrical, and signaling circuitry for communicating data over physical links coupled to the network. The network interfaces may be configured to transmit and/or receive data using a variety of different communication protocols, as known by those skilled in the art.

The memory 240 comprises a plurality of locations that are addressable by the processor(s) 220 and the network interfaces 210 for storing software programs and data structures associated with the embodiments described herein. The processor(s) 220 may comprise necessary elements or logic adapted to execute the software programs and manipulate the data structures. An operating system 242, portions of which are typically resident in memory 240 and executed by the processor(s), functionally organizes the node by, inter alia, invoking network operations in support of software processes and/or services executing on the node. These software processes and/or services may comprise grocer services 244 that facilitate communication between each entity and the CDPP 108. Specifically, grocer services 244 contain computer executable instructions executed by processor(s) 220 to perform functions associated the distribution and processing of electronic coupons, and more specifically, for allowing the manufacturer node, grocer node, and shopper to receive services from the CDPP 108, as described below.

The CDPP 108 may further include a web server 246. The web server 246 delivers/serves up web pages to the different entities. For example, the web server 246 of the CDPP 108 may utilize a client/server model and the World Wide Web's Hypertext Transfer Protocol (HTTP) to serve files that form web pages, as described below, to users (e.g., manufacturer node 102, grocer entity node 104, financial services institution node 110, banking institution node 112, and POS node 116).

Further, it will be apparent to those skilled in the art that other types of processors and memory, including various computer-readable media, such as non-transitory computer readable medium, may be used to store and execute program instructions pertaining to the techniques described herein. Also, while the embodiments herein are described in terms of processes or services stored in memory, alternative embodiments also include the processes described herein being embodied as modules consisting of hardware, software, firmware, or combinations thereof. Further, it is noted that the other entities (e.g., manufacturer node 102, grocer entity node 104, financial services institution node 110, banking institution node 112, and POS node 116) illustratively have similar hardware components to that of the CDPP 108.

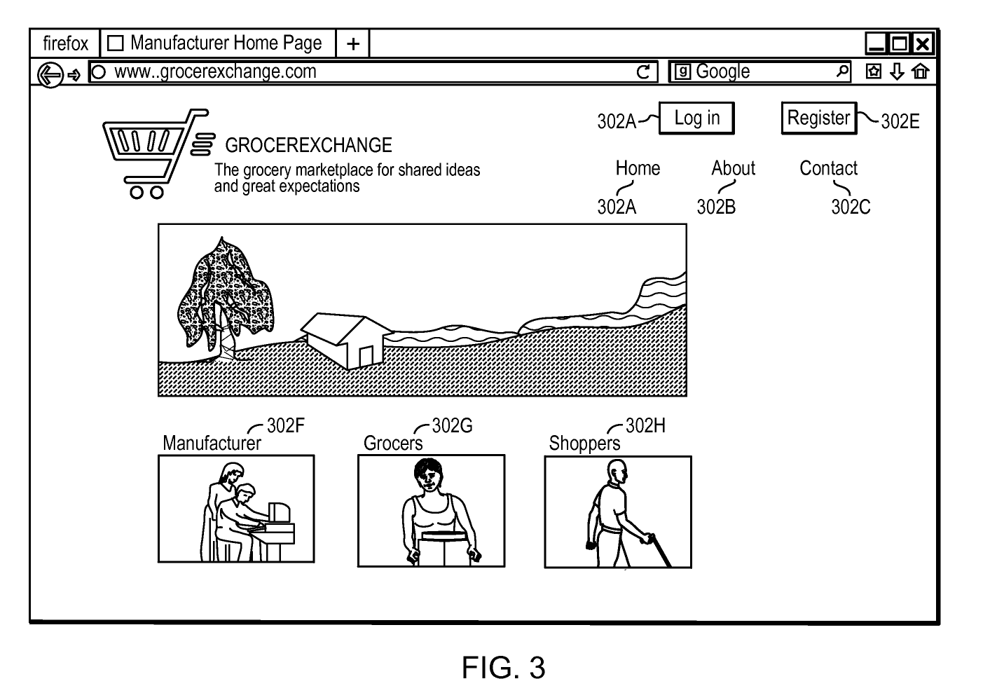

FIG. 3 is an exemplary screenshot of a web page illustrating a home screen 300 in accordance with an illustrative embodiment of the present invention. Specifically, the home screen 300 may be reached by inputting a specific uniform resource locator (URL) or a web address in a web browser, as known by those skilled in the art. The home screen 300 illustratively includes one or more tabs 302 that allow users to interact with the CDPP 108. Specifically, tabs 302 may include, but are not limited to, a home tab 302A, an about tab 302B, a contact tab 302C, a login tab 302D, a register tab 302E, a manufacturer tab 302F, a grocer tab 302G, and a shopper tab 302H.

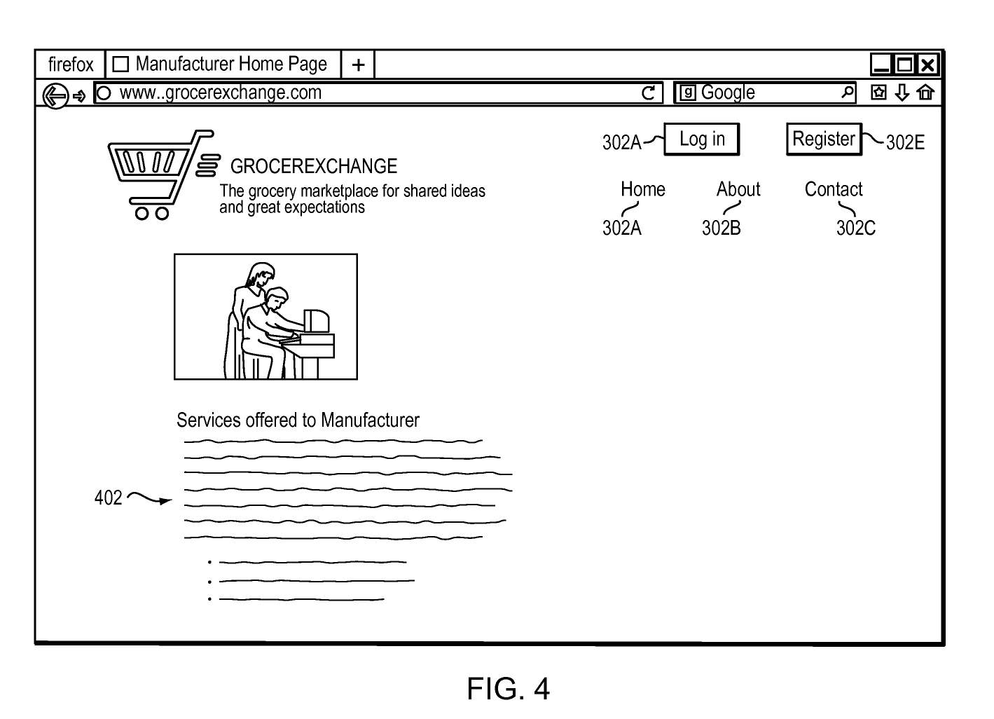

If a user selects a particular tab 302, the user may be brought to a different web page associated with a different URL. The home tab 302A may be selected by a user to bring the user back to home screen 300 at any point in time. For example, when the user selects various tabs and move to different web pages, as shown in FIGS. 4, 5, and 7, the user may select the home tab 302A to come back to the home screen 300. The About tab 302B may be selected by a user to obtain background information regarding the CDPP 108 and the program implemented by the CDPP 108. For example, such information may indicate, but is not limited to, the goal of the CDPP 108, when the program implemented by the CDPP 108 was started, etc. The contact tab 302C may be selected by a user to obtain contact information, such as an email or a phone number, associated with the CDPP 108. For example, the emails or phone number may be associated with individuals who work for the CDPP 108, and can assists users and answer questions the users may have.

The login tab 302D may be selected by a user to login to an account of the CDPP 108, wherein the account is associated with the user or entity that the user may work for or be associated with. For example, a chief financial officer (CFO) or other authorized user acting on behalf of a particular manufacturer or grocer entity may provide a username and password, after selecting the login tab 302D, to gain access to a particular account associated with the CDPP 108. Alternatively, a shopper may provide a username and password, after selecting the login tab 302D, to gain access to his/her account. Specifically, a user may utilize a hardware device, such as a laptop, to input the username and password into one or more graphical user interface (GUI) windows/screens provided by the CDPP 108. If the correct username and password are provided, the user is given access to the account. If the correct username and password are not provided, the user may be provided an error message, as known by those skilled in the art.

If a particular manufacturer, grocer, or shopper does not have an established account, a new account can be created. Specifically, an authorized user acting on behalf of a manufacturer or grocer entity may select register tab 302E and provide particular information to establish the new account. For example, the authorized user may enter address information, bank account information, and other information associated with the manufacturer or grocer entity. It is noted that in most instances, only those authorized individuals have certain proprietary information needed to setup a legitimate account on behalf of the manufacturer and the grocer entity. Further, a shopper may provide particular user information to establish the new account. For example, the shopper may provide personal information, such as name, address, etc., to establish the new account. Once the new account is established and set up, a username and password may be provided so that the manufacturer, grocer entity, and shopper can select login tab 302D to access the particular account. For example, the CDPP 108 may email the username and password to the user.

The manufacturer tab 302F may be selected by a user interested in learning about the services offered to manufacturers by the CDPP 108. Specifically, by selecting manufacturer tab 302F, the user may be brought to a new web page or URL that provides a description of the services provided to a manufacturer by the CDPP 108. FIG. 4 is an exemplary screenshot of a web page illustrating a GUI screen after selecting the manufacturer tab 302F in accordance with an illustrative embodiment of the present invention.

For example, the description 402 may indicate that the CDPP 108 provides advertising and sales promotion channels for manufacturers, and enable manufacturers to directly and effectively deliver marketing communications to shoppers and independent grocer entities in different markets, such as urban markets. For example, the CDPP 108 may advertise for products of the manufacturer at particular grocer entities. Further, the CDPP 108 may capture cash register data that the CDPP 108 then utilizes to create statistical market reports that are provided to the manufacturer. Other analytical information associated with the manufacturer's products may be gathered by the CDPP 108 and provided to the manufacturer.

For example, the manufacturer may receive, from the CDPP 108, information regarding the placement of its products on particular shelves at the grocer entities. The manufacturer may utilize this information to then alter its marketing resources or provide feedback to the CDPP 108, wherein the CDPP 108 may utilize the feedback to change the placement of the manufacturer's products. It is noted that the CDPP 108 can collect and report data in near real time through use of a wireless network 118 or any type of network, such that comprehensive and accurate reports may be available to the manufacturer by accessing its account associated with the CDPP 108. Other services, such as QR bar coding programs, in-store product sampling and demo programs, in-store mobile phone advertisement programs, and in-store mobile phone surveys may be provided to the manufacturer by the CDPP 108. For example, the manufacturer may login and access its account and select one or more services utilizing GUI screens provided by CDPP 108. The grocer services 244 of the CDPP 108 may design and implement the services selected by the manufacturer.

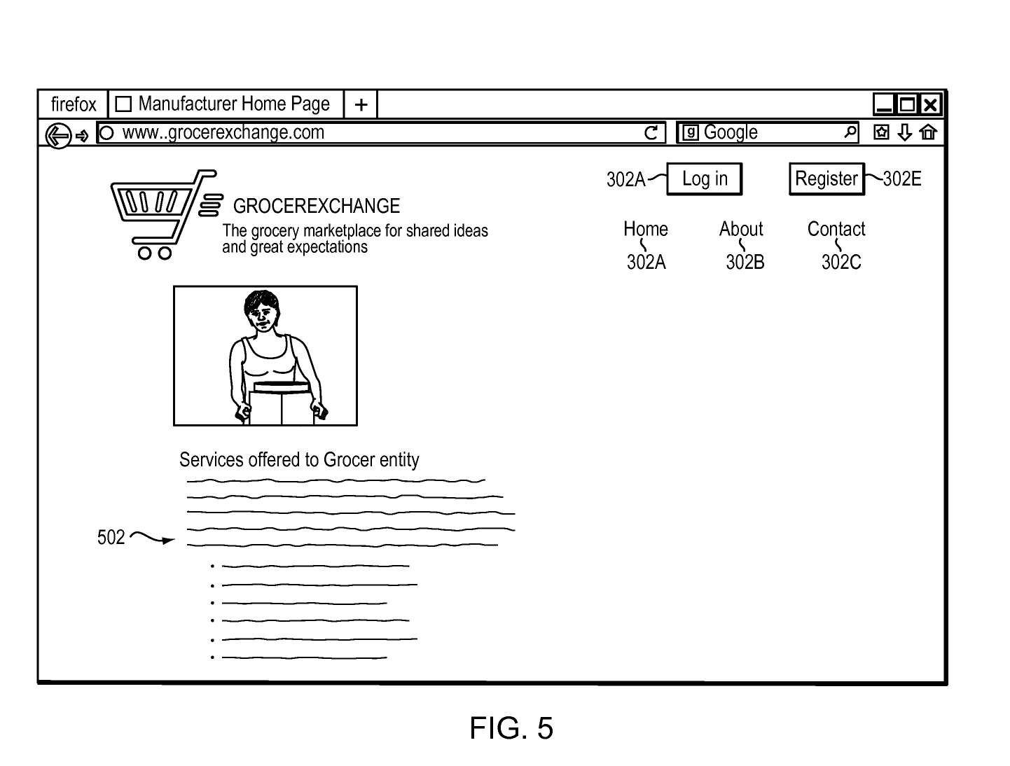

The grocer tab 302G may be selected by a user interested in learning about the services offered to grocer entities by the CDPP 108. Specifically, by selecting the grocer tab 302G, the user may be brought to a new web page or URL that provides a description of the services provided to the grocer entity by the CDPP 108. FIG. 5 is an exemplary screenshot of a web page illustrating a GUI screen after selecting the grocer tab 302G in accordance with an illustrative embodiment of the present invention.

For example, the description 502 may indicate that the CDPP 108 provides advertising, sales promotion channels for grocer entity, and enables grocer entities to directly and effectively deliver marketing communications to shoppers. For example, the CDPP 108 may advertise for the grocer entity on shopping carts, billboards, etc. Further, the CDPP 108 may captures data for the grocer entity that allows the grocer entity to better understand the marketplace and its customers. For example, the CDPP 108 may implement a mobile application to gather survey data and/or feedback from shopper's regarding their experience at the grocer entity. That data may be organized by the CDPP 108, and the grocer entity may login and access the associated account to view the data. Advantageously, the grocer entity may utilize that data to better serve its customers. Other information, data, and services may be provided by the CDPP 108 to the grocer entity, and the description of the CDPP 108 providing data and advertising services to the grocer entity is simply exemplary in nature.

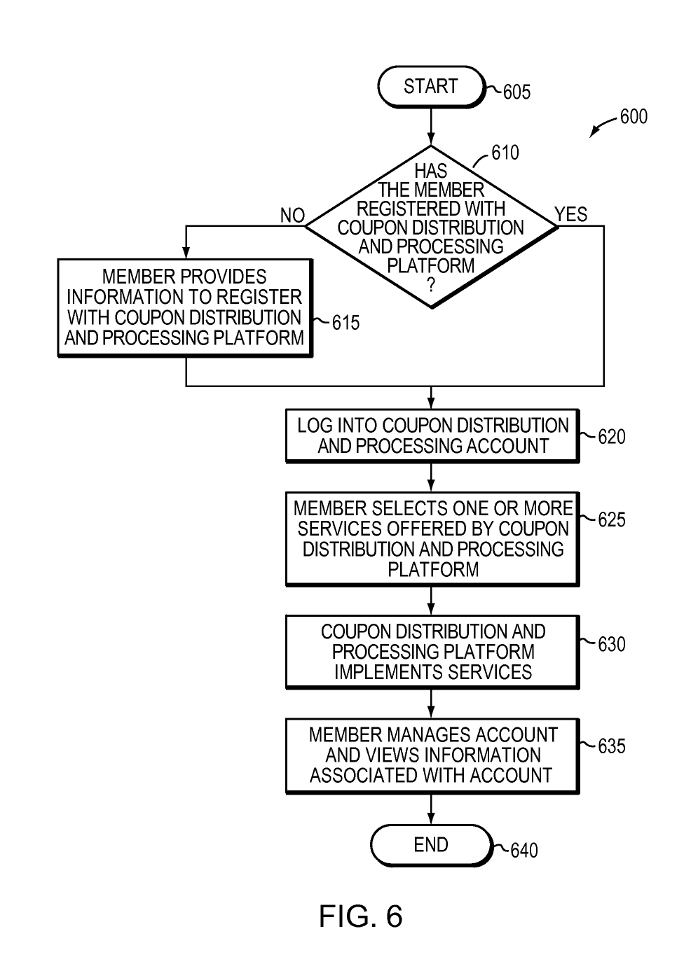

FIG. 6 is an exemplary flowchart detailing the steps of a procedure 600 for interaction between a manufacturer node and/or a grocer entity node with the CDPP in accordance with an illustrative embodiment of the present invention. Specifically, procedure 600 start at step 605 and continues to step 610 wherein it is determined whether a member (e.g., manufacturer or grocer entity) is registered with the CDPP 108 and has a corresponding account. If at step 610 it is determined that the member has registered with the CDPP 108 and has a corresponding account, the procedure branches to step 620. If at step 610 it is determined that the member has not registered with the CDPP 108 and does not have a corresponding account, the procedure branches to step 615 where an authorized user on behalf of the member (e.g., manufacturer or grocer entity) provides pertinent information to register with the CDPP 108 and establish a corresponding account. For example, the authorized user may utilize a personal computer, a laptop, a tablet, or a different hardware device to input such pertinent information into one or more GUI screens provided by the CDPP 108. The authorized user may enter address information, bank account information, and other information associated with the manufacturer or grocer entity into the GUI screens. It is noted that in most instances, only those authorized individual have certain proprietary information needed to setup a legitimate account on behalf of the manufacturer and grocer.

The procedure then continues on to step 620. At step 620, an authorized user on behalf of the member logs into the corresponding account by providing a username and password obtained after registering with the CDPP 108. At step 625, the authorized user may select one or more services offered by the CDPP 108 to the member. For example, the authorized user may request particular statistical data, advertising services, an in-store demo program, and may also provide electronic coupons to the CDPP 108 that may be utilized by the shopper 106, as described in more detail below.

Specifically, the CDPP 108 may install hardware and/or software onto the POS node 116 associated with the grocer entity. Thereafter, and as shoppers purchase products, the data associated with the POS nodes 116 may be captured and compiled by the hardware and/or software installed on the POS node 116, and transmitted to the CDPP 108 for organization and storage. The captured data may then be provided to the manufacturer and/or grocer entity, through the manufacture and/or grocer entity accessing their corresponding accounts. At step 630, the CDPP 108 may implement the services selected by the authorized user. At step 635, the authorized user manages the corresponding account and views information associated with the account. For example, the authorized user may manage the manufacturer's or grocer's bank account that may be maintained by a financial services institution node 110/banking institution node 112. At step 640, the procedure ends.

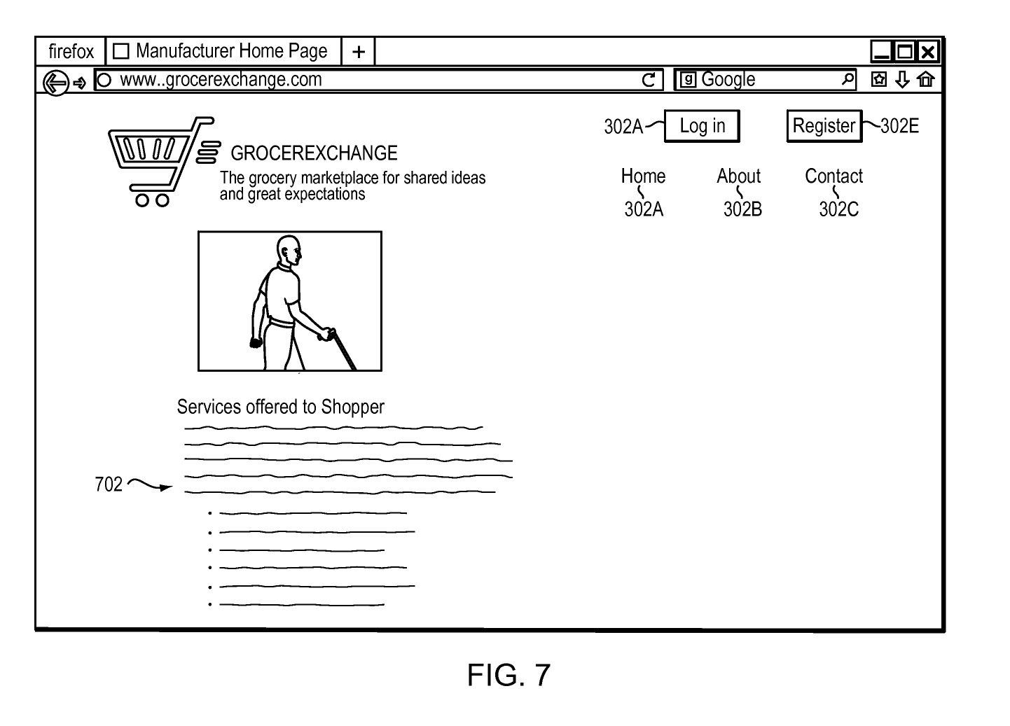

Referring back to FIG. 3, the shopper tab 302H may be selected by a user interested in learning about the services offered to shoppers by the CDPP 108. Specifically, by selecting the shopper tab 302H, the user may be brought to a new web page or URL that provides a description of the services provided to the shopper by the CDPP 108. FIG. 7 is an exemplary screenshot of a web page illustrating a GUI screen after selecting the shopper tab 302G in accordance with an illustrative embodiment of the present invention. The description 702 describes services that may be provided to the shopper 106 that may include, but are not limited to, receiving information about upcoming discounts, promotions, and coupons so that the shopper can plan shopping trips to save money.

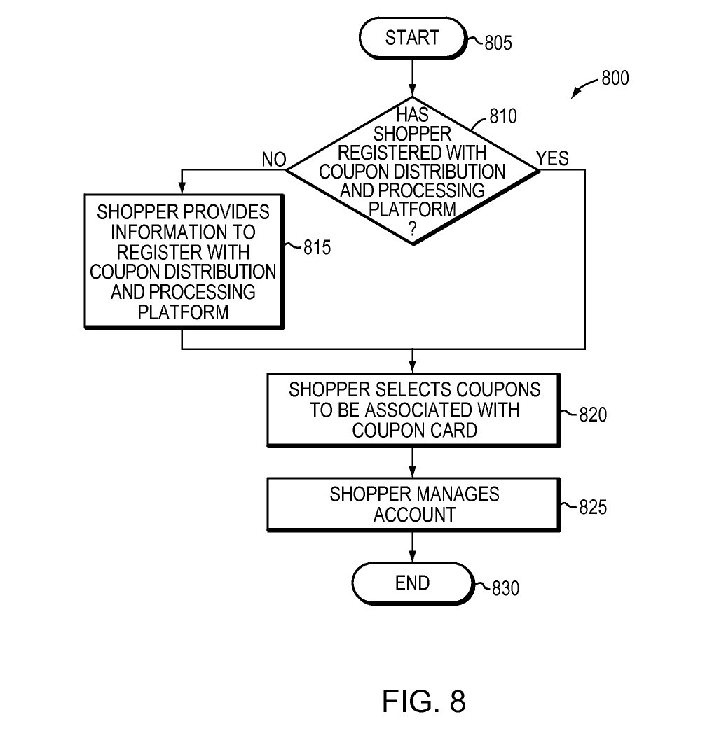

FIG. 8 is an exemplary flowchart detailing the steps of a procedure 800 for interaction between a shopper and the CDPP in accordance with an illustrative embodiment of the present invention. Specifically procedure 800 start at step 805 and continues to step 810 wherein it is determined whether a shopper is registered with the CDPP 108 and has a corresponding account. If, at step 810, it is determined that the shopper has registered with the CDPP 108 and has a corresponding account, the procedure branches to step 820. If at step 810 it is determined that the shopper has not registered with the CDPP 108 and does not have a corresponding account, the procedure branches to step 815 where a shopper provides pertinent personal information to register with the CDPP 108 and establishes a corresponding account. For example, the shopper may utilize a personal computer, a laptop, a tablet, or a different hardware device to input such personal information (e.g., name, address, etc.) into one or more GUI screens provided by the CDPP 108. After registering, the shopper may receive a username and password via email and a coupon card 133 via mail, for example. The financial services institution may issue and mail the coupon card 133 to the shopper after performing certain actions, such as a credit check, etc. The procedure then continues on to step 820.

At step 820, the shopper electronically selects one or more coupons associated with one or more products of interest, to be associated with the shopper's coupon card 133. For example, the shopper may first login to his/her corresponding account utilizing a username and password. The shopper may then electronically select coupons associated with products the shopper wishes to purchase at the grocer entity (registered with the CDPP 108), wherein the product are associated with a manufacturer (registered with the CDPP 108). More specifically, the shopper may navigate one or more web pages associated with the CDPP 108 and select (i.e., “load”) electronic coupons that the shopper wishes to utilize at the grocer entity. Thereafter, when the shopper 106 has the coupon card 133 scanned at the POS node 116 or credit card 137 scanned at payment terminal node 104, the CDPP 108 can determine, based on identification information associated with the shopper 106, if the products purchased at the grocer entity are associated with electronic coupons that were previously selected by the shopper 106 utilizing the web pages associated with the CDPP 108. If the products are associated with coupons previously selected by the shopper 106, the CDPP 108 credits the shopper's account, as explained below.

In alternative embodiments, the shopper 106 may not be required to select the electronic coupons via the web pages associated with the CDPP. Instead, the CDPP 108 may credit the shopper's account simply based on the fact that the shopper 106 purchased the product at the grocer entity. Advantageously, the manufacturer can automatically provide particular coupons to shoppers without requiring the shopper to select the coupons. It is further noted that the shopper 106 may qualify for particular coupons based on certain criteria. For example, a manufacturer may indicate that an electronic coupon should be provided to a shopper if the shopper purchases a certain number of products or if the shopper has been provided certain advertisements, etc. As such, the description of a shopper selecting particular coupons, or the shopper automatically being provided particular coupons without selection, are to be taken as exemplary only.

At step 825, the shopper manages his/her account. For example, the shopper may utilize one or more GUI screens provided by the CDPP 108 to indicate the manner in which the accumulated savings, obtained utilizing the coupon card 133, should be applied. The shopper may put the accumulated savings towards a minimum payment requirement of a credit card that the shopper is currently utilizes. For example, the credit card may be associated with the financial institution through which the user obtained the coupon card 133. In alternative embodiments, the accumulated savings may be stored in a financial account associated with the shopper, where the financial account may be maintained by a particular banking institution. For example, the CDPP 108 may apply the shopper's accumulated savings to the minimum payment requirement for the credit card, and then deposit the remaining savings in the shopper's bank account. Alternatively, the remaining savings may be applied to the remaining balance of the credit card, or paid out in any manner selected by the shopper. Further, the shopper may indicate that the saving should be aggregated by the CDPP 108, and then applied in the selected manner periodically (e.g., at the end of the month). At step 830, the procedure ends.

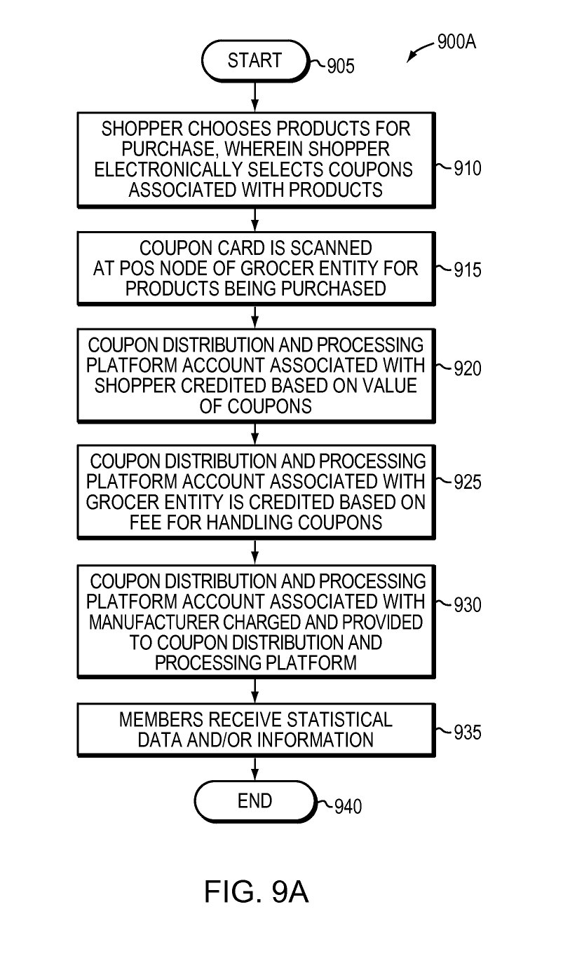

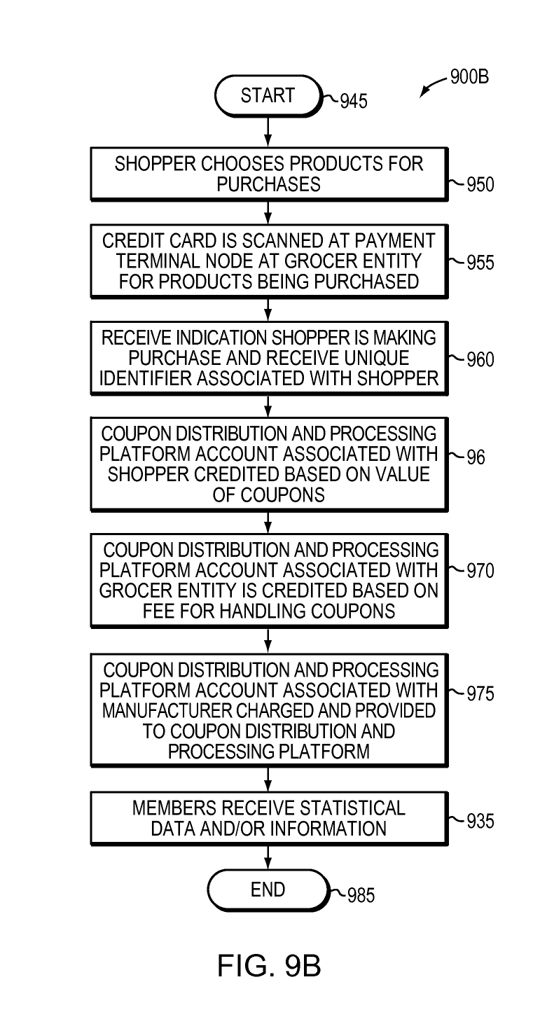

FIG. 9A is an exemplary flowchart detailing the steps of a procedure 900A for distributing and processing coupons in accordance in accordance with an illustrative embodiment of the present invention. Specifically, procedure 900 starts at step 905 and continues to step 910 where the shopper, having an account associated with the CDPP 108 and the coupon card 133, enters a grocer entity and selects one or more products for purchase. It is noted that the shopper may have previously electronically selected coupons, for products, that are associated with the shopper's coupon card 133, as described with reference to FIG. 8. Further, it is noted that the grocery entity and the manufacturer of the products both have accounts associated with the CDPP 108. The manufacturer may have requested specific services utilizing its corresponding account. For example, the manufacturer of laundry detergent may utilize its corresponding account to request that as shoppers enter particular grocery stores, the shoppers are to receive electronic promotions regarding the new laundry detergent. As such, when the shopper enters the grocery store, the shopper's mobile phone or other device may receive, from the CDPP 108, a message or image promoting the new laundry detergent over the cellular network 120.

At step 915, the shopper's coupon card 133 is scanned at POS node 116 of the grocer entity, such as a cash register, for the products purchased. Specifically, and as explained above, the POS node 116 has hardware and/or software loaded thereon. Thus, when the coupon card 133 is scanned at the POS node 116, the CDPP 108 can receive an indication that the shopper is making a purchase, and determines if the product purchased has a corresponding electronic coupon. For example the shopper may have previously selected electronic coupons (e.g., utilizing web pages associated with the CDPP 108) to be associated with the coupon card 133. In alternative embodiments, the manufacturer may have indicated that the shopper is to be automatically provided an electronic coupon for the product purchased without requiring the shopper to select the electronic coupon.

At step 920, the account associated with the shopper is credited based on the value of the coupon. The credit may be applied to the shopper's account in a manner selected by the shopper. For example, the shopper may have previously accessed his/her corresponding account and indicated that the credit or saving should be applied to a minimum payment requirement for a credit card. As such, the accumulated savings may be temporarily stored in a financial account maintained by a particular banking institution, and then applied to the minimum payment requirement for the credit card at a later time (e.g., end of the month). Alternatively, the shopper may have indicated that the credit or accumulated savings should be stored in a financial account associated with the shopper and maintained by a particular banking institution. In any case, by scanning the shopper's coupon card at the POS node 116 of the grocer entity, the shopper receives accumulated savings, based on the electronic coupons, and those accumulated savings are provided to the shopper in a manner selected by the shopper.

At step 925, the account associated with the grocer entity may be credited based on a fee for handling the coupon, wherein the account may be maintained by the banking institution. For example, if the shopper has utilized four electronic coupons previously selected and associated with its coupon card 133 when the coupon card 133 is scanned at the POS node 116, the financial account associated with the grocer entity may be credited (e.g., $0.08) based on a handling fee associated with each electronic coupon. Advantageously, the grocer entity 104 does not bear the financial burden associated with waiting until a coupon is compensated through a coupon settlement process, as is the case with tradition paper coupons. In addition, the grocer entity does not have to wait for a clearinghouse settlement process to take place and thus does not have to essentially carry the face value float of the coupon for an extended period of time. Instead, by being a member of the CDPP 108, the grocer entity avoids these encumbrances and is simply an un-acting intermediary that may receive financial compensation (e.g., handling fee) in a timely fashion.

At step 930, the financial account associated with the manufacturer may be charge/debited and provided to the CDPP 108. For example, the CDPP 108 may have a financial account maintained by a particular banking institution. In response to the scanning of the shopper's coupon card 133, the fee (e.g., $0.10) may be transferred from the financial account associated with the manufacturer to the financial account associated with the CDPP 108. As such, the four entities: the manufacturer, the grocer entity, the shopper, and the CDPP 108 are affected based on the scanning of the coupon card 133 at the POS node 116.

At step 935, the members (e.g., manufacturers, grocer entities, and shoppers) receives statistical data and/or information. As explained above, data associated with the POS node 116 may be captured and compiled by the hardware and/or software installed on the POS node 116, and transmitted to the CDPP 108 for organization and storage. Specifically, the manufacturer may access its corresponding account and view the captured data. Advantageously, the manufacturer can get real time statistics regarding the sale of its products at grocer entities, and utilize this information to alter its business practices. Further, the CDPP 108 may collect statistical data or survey data regarding shopper's tendencies, etc., and store such information on the CDPP 108. The grocer entity may access its corresponding account and view this information. Moreover, the shopper may receive promotional information or other data based on its buying patterns, after logging into the corresponding account. At step 940, the procedure ends.

FIG. 9B is an exemplary flowchart detailing the steps of a procedure 900B for distributing and processing coupons in accordance in accordance with an illustrative embodiment of the present invention. Specifically, procedure 900B starts at step 945 and continues to step 950 where the shopper, having an account associated with the CDPP 108, enters a grocer entity and selects one or more products for purchase. It is noted that the shopper may have previously electronically selected coupons, for products. Further, it is noted that the grocery entity and the manufacturer of the products both have accounts associated with the CDPP 108.

At step 955, the shopper's credit card 137 is scanned at payment terminal node 140 at the grocer entity, that is associated with the financial services institution node 110. At step 960, and in response to the credit card 137 being scanned, the CDPP 108 receives an indication that the shopper is making a purchase and receives from the financial services institution node 110 a unique identifier associated with the shopper.

At step 965, the account associated with the shopper is credited based on the value of the electronic coupon. For example, the shopper may have previously selected electronic coupons (e.g., utilizing web pages associated with the CDPP 108). In alternative embodiments, the manufacturer may have indicated that the shopper is to be automatically provided an electronic coupon for the product purchased without requiring the shopper to select the electronic coupon utilizing the CDPP 108.

At step 970, the account associated with the grocer entity may be credited based on a fee for handling the coupon, wherein the account may be maintained by the banking institution. At step 975, the financial account associated with the manufacturer may be charge/debited and provided to the CDPP 108. At step 980, the members (e.g., manufacturers, grocer entities, and shoppers) receives statistical data and/or information. At step 985, the procedure ends.

The foregoing description described certain exemplary embodiments. It will be apparent, however, that other variations and modifications may be made to the described embodiments, with the attainment of some or all of their advantages. For instance, it is expressly contemplated that instead of the shopper utilizing the coupon card, a mobile application, or other virtual card or device may be utilized by the shopper and scanned at POS node (e.g., a register). For example, a virtual card operating on a mobile application on a mobile device may serve as the coupon card. Further, although reference is made to a grocer entity, the CCDP may be utilized with any type of store (e.g., department store, online store, etc.) that sells products or services to consumers. Accordingly, the foregoing description is to be taken only by way of example, and not to otherwise limit the scope of the disclosure. It is the object of the appended claims to cover all such variations and modifications as come within the true spirit and scope of the disclosure.

What is claimed is:

1. A method, comprising:
maintaining, by a coupon distribution and processing platform (CDPP) having at least one processor and a memory, one or more webpages;
establishing a shopper account associated with a shopper based on a first registration process utilizing the one or more web pages;
establishing a grocer account associated with a grocer entity based on a second registration process utilizing the one or more web pages:
establishing a manufacturer account associated with a manufacturer based on a third registration process utilizing the one or more web pages;
scanning a card device at a point of service (POS) node for a product, where the POS node is maintained at the grocer entity and includes hardware and software associated with the CDPP, where the card device is associated with at least one coupon for the product, and in response to the scanning the card device at the POS node maintained by the grocer entity;
determining, by the CDPP, an amount to credit the shopper account associated with the card device, wherein the amount credited to the shopper account is based on a value of the at least one coupon;
crediting, by the CDPP, the grocer account associated with the grocer entity that sells the product to the shopper; and
debiting, by the CDPP, the manufacturer account associated with the manufacturer of the product, and providing the amount debited from the manufacturer account to a financial account associated with the CDPP.

2. The method of claim 1, wherein the amount credited to the grocer account is based on a fee for handling the coupon.

3. The method of claim 1, wherein the at least one coupon is an electronic coupon selected by the shopper and associated with the card device by the shopper utilizing the one or more web pages maintained by the CDPP.

4. The method of claim 1, wherein the shopper receives the card device from a financial institution, and wherein the shopper also obtains a credit card from the financial institution.

5. The method of claim 4, wherein the amount credited to the shopper account further comprises:
applying a portion of the amount to a minimum amount requirement associated with the credit card; and
storing the remainder of the amount in the shopper account that is maintained by a banking institution.

6. The method of claim 1, further comprising:
selecting, by the shopper an authorized user associated with the grocer entity, and an authorized user associated with the manufacturer, one or more services; and
implementing, by the at least one processor of the CDPP, the one or more services selected by the shopper, the authorized user associated with the grocer entity, and the authorized user associated with the manufacturer.

7. The method of claim 6, wherein the services include at least one of receiving promotions regarding products, receiving advertising services, receiving statistical data regarding sales of products.

8. The method of claim 1, wherein receiving the promotions regarding products further comprises:
receiving a message on a mobile device associated with the shopper, wherein the message is a promotion for a particular product manufactured by a particular manufacturer and sold at a particular grocer entity.

9. An apparatus comprising:
one or more network interfaces adapted to communicate data over a computer network;
a processor coupled to the network interfaces and adapted to execute one or more processes; and
a memory configured to store a process executable by the processor, the process when executed operable to:
maintain one or more webpages;
establish a shopper account associated with a shopper based on a first registration process utilizing the one or more web pages;
establish a grocer account associated with a grocer entity based on a second registration process utilizing the one or more web pages;
establish a manufacturer account associated with a manufacturer based on a third registration process utilizing the one or more web pages;
receive an indication that a card of the shopper was scanned at a point of service (POS) node associated with a grocer entity to purchase a product, wherein the card has a coupon associated with the product loaded thereon and where the POS node is maintained by the grocer entity, and in response to the card being scanned the apparatus configured to:
determine an amount to credit the shopper account associated with the shopper, wherein the amount credited to the shopper account is based on a value of the coupon,
credit the grocer account associated with the grocer entity, where the amount credited to the grocer account is based on a fee for handling the coupon, and
debit the manufacturer account associated with the manufacturer of the product based on the purchase of the product.

10. The apparatus of claim 9, wherein the coupon is an electronic coupon chosen by the shopper and associated with the card.

11. The apparatus of claim 10, wherein the process when executed is further operable to:
maintain the one or more web pages utilized to choose the coupon that is associated with the card.

12. The apparatus of claim 9, wherein the process when executed is further operable to:
apply a portion of the amount, credited to the shopper account, to a minimum payment requirement of a credit card of the shopper; and
apply a remainder of the amount, credited to the shopper account, to a financial account associated with the shopper and maintained by a banking institution.

13. The apparatus of claim 9, wherein
the one or more web pages include graphical user interface (GUI) screens so that the shopper, the grocer entity, and the manufacturer can select one or more services.

14. The apparatus of claim 13, wherein the services include at least one of receiving promotions regarding products, receiving advertising services, and receiving statistical data regarding sales of products.

15. A system, comprising:
one or more network interfaces adapted to communicate data over a computer network;
a processor coupled to the network interfaces and adapted to execute one or more processes; and
a memory configured to store a process executable by the processor, the process when executed operable to:
maintain one or more web pages having graphical user interface (GUI) screens, wherein a manufacturer of a product, a seller of the product, and a shopper of the product utilize the GUI screens to respectively establish a manufacturer account, a seller account, and a shopper account, wherein one or more services are selected by the manufacturer, seller, and the shopper utilizing the GUI screens;
implement the one or more selected services;
credit the shopper account associated with the shopper and the seller account associated with the seller in response to a card, associated with the shopper, being scanned at a point of service (POS) node to purchase the product utilizing an electronic coupon; and
debiting the manufacturer account associated with the manufacturer in response to the card, associated with the shopper, purchasing the product utilizing the electronic coupon.

16. The system of claim 15, wherein the shopper account associated with the shopper is credited by applying a portion of savings, realized by the card being scanned at the POS node to purchase the product, to a minimum payment requirement of a credit card utilized by the shopper.

17. The system of claim 15, wherein a different portion of the saving, realized by the card being scanned at the POS node to purchase the product, is applied to a financial account of the shopper maintained by a banking institution.

18. The system of claim 15, wherein an amount credited to the seller account is based on a fee for handling the coupon.

19. The system of claim 15, wherein the services include at least one of receiving promotions regarding products, receiving advertising services, receiving statistical data regarding sales of products.

20. The system of claim 15, wherein the electronic coupons are selected by the shopper utilizing the GUI screens of the one or more web pages.
